(19) United States
(12) Patent Application Publication
(10) Pub. No.: US 2006/0070247 A1
(43) Pub. Date: Apr. 6, 2006

(54) Universal hunting tool - "the rangerman"

(76) Inventor: Dan Jeffrey Smilanich, Britt, MN (US)

Correspondence Address: DAN SMILANICH;c/o TRESIA A. TRELOAR, P.O. BOX 12622, JACKSONVILLE, NC, 28546, US

(21) Appl. No.: 10/958,042

(22) Filed: Oct. 5, 2004

(51) Int. Cl. B26B 23/00

(52) U.S. Cl. 30/308.1

(57) ABSTRACT

The single universal tool allows for separate use of each portion of the tool. It is a chrome plated one-piece unit that has a beveled blade with upper and lower surfaces opposite the end of its four-finger grip combined with the elongated handle creating a major combination of knife, meat cleaver, hatchet, along with its other uses. The blade has a spiky top of the upper surface, with a fore finger/hanger hole located in the center of the blade. The bottom of the lower surface is slightly beveled and sharpened at its edge that ends in a tip pointed at the front end opposite the handle. The front edge of the lower surface from the tip is also slightly beveled with a sharpened edge and concave upward to the middle of the blade surface, naturally curving outward forming a head, the head is not sharpened and meets the spiky top.

### BACKGROUND OF THE INVENTION

A single universal tool allowing for separate use of each portion of the tool in place of different tools required for various activities associated with hunting, trapping, fishing, and camping while exploring the wild. The tool is a slightly beveled surfaced universal object, without the need of changing from tool to tool. This tool is designed with various features into one body template. The different designs of this body template with the use of the tool's four-finger grip and pistol grip is to be used in performing different cutting, chopping, skinning, and crushing techniques associated with hunting, fishing, and including, but limited to camping. It is the purpose of the present invention to provide these features in an universal hunting tool.

### SUMMARY OF THE INVENTION

A slightly beveled metal surface designed with different designs into one object without switching between tools. Unlike other sets that have different components by switching from tool to tool by unfolding one component and refolding another component to a singular unit through swivel motion, this design is one steel surface. The object is one unit, not many units combined, creating one complete system. This eliminates the steps to change between objects, making this invention more convenient and saving time. With this universal tool, there is no need to carry many utensils and or tools because they are all in one. This one tool as opposed to many tools also makes for a lighter load. A all in one slightly beveled surface unit made with different points, and angles configured with a fore finger/hanger hole within the face of the steel plate attached to a grip handle elongated with a riveted handle at the end. All the unit requires is a changing of direction in the hand at the handle, grip, or fore finger/hanger hole. To care for the item never requires cleaning separate or many units, there is just one unit to clean. The features of the present invention are made obvious to those of ordinary skill in the art after reading of the following description of the universal hunting tool.

### BRIEF DESCRIPTION OF THE DRAWING FIGURES

FIG. 1 is a perspective view, taken from the side of the invention as is described in the “Detailed Description” with designs 1 through 11.

FIG. 2 is a perspective view, taken from the side of the invention as a single template with designs 1, 2, 3, 4, 5, 6, 8, 9, and 10.

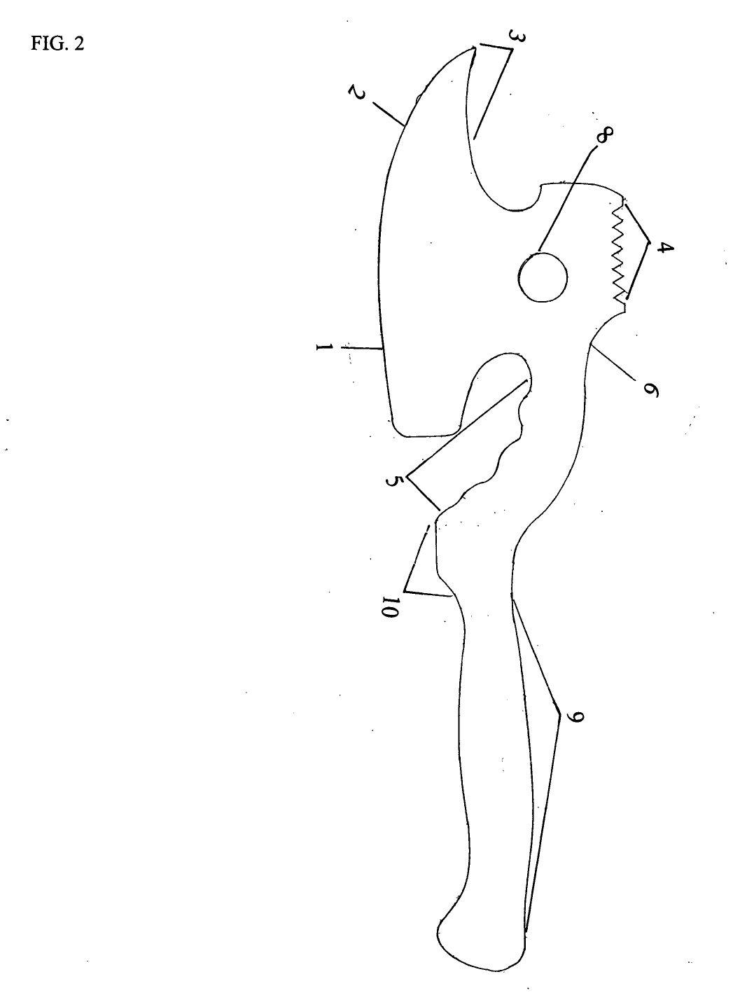

FIG. 3 is a perspective view, taken from the side of the invention as is described in the “Detailed Description” only including the designs 1, 2, 3, 4, 6, and 8, made in the “Claim”.

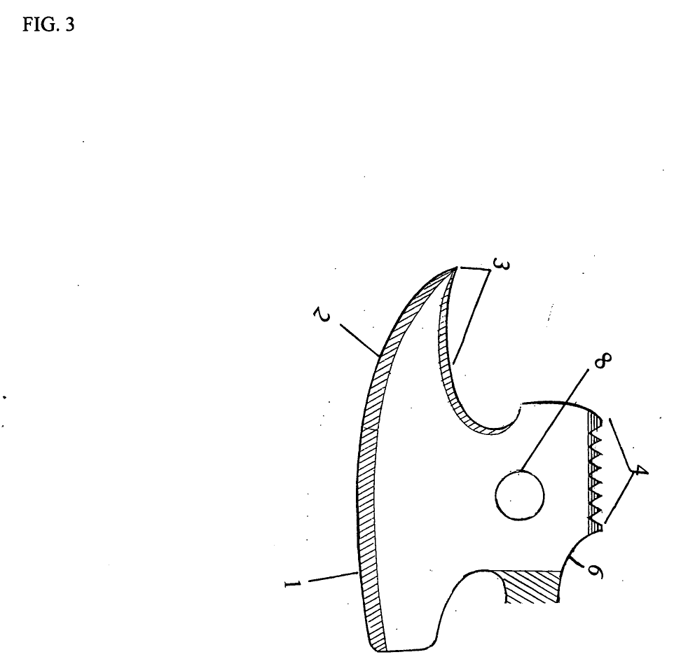

### DETAILED DESCRIPTION

In the following description, terms such as above, below, top, bottom, side, lower, upper, front, back, upward, southward, and the like are used solely for the purpose of clarity in illustrating and describing the invention, and should not be taken as words of limitation.

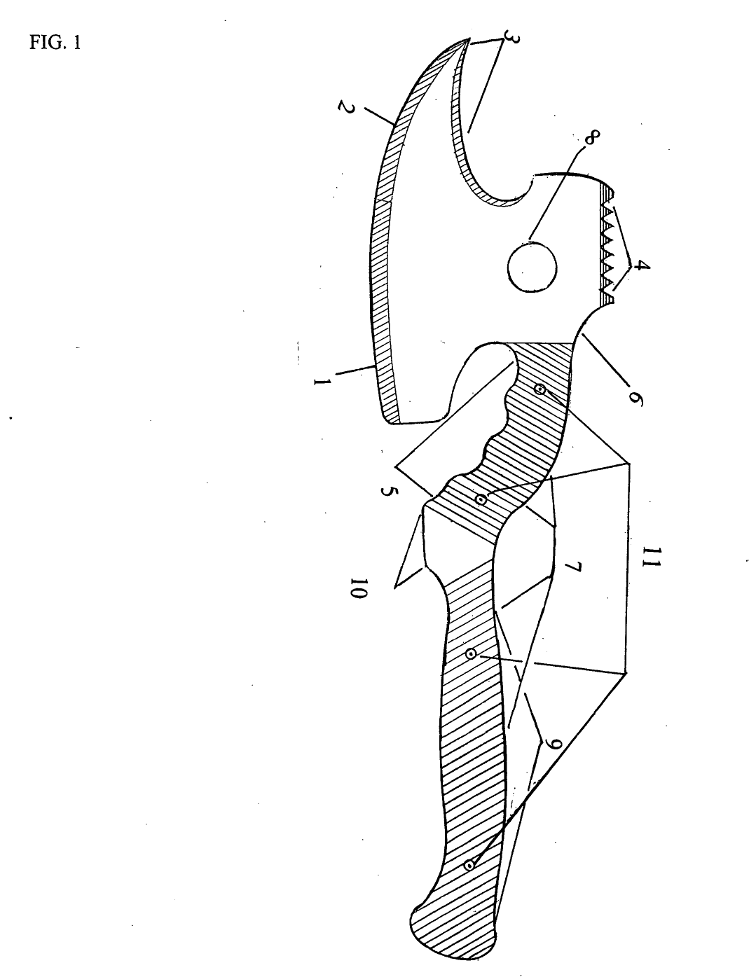

A finished design of the invention from it's perspective side shown in FIG. 1, is made up of designs 1, 2, 3, 4, 5, 6, 7, 8, 9, and 11 furthered described below. The invention as described is a slightly beveled steel surface referred to as it's main body template. Within the slightly beveled steel surface face 1. at the front of the template is a fore finger/hanger hole 8. is in its center, the face at its bottom curves conspicuously upward into a four-finger grip handle 5. with indentations for placement of the point finger through the pinky finger and then elongates into a long handle 9. with riveted handles covering the beginning to ending area of the four-finger handle 5. and then beginning again at least 1″ from the ending of the four-finger grip handle 5. to cover the beginning to ending area of the long handle 9.

This structure has a slightly beveled steel surface with a fore finger/hanger hole 8., drilled in its center for the natural placement of the forefinger for accurate usage of the knife tip 2 and 3 or as a hook hanger. The slightly beveled steel surface has a sharpened edge 1. for wood chopping, and meat cleaning and expands forward as the lower knife-edge 2. for regular knife usage, trimming, and skinning ending in 3. Located opposite end of the riveted long handle 9., 3. is a pointed tip, concaving upward with a sharpened edge used for the purpose of rope cutting and field dressing. The section 3. of the unit is southward the top 4. The top 4. has a spiky surface for bone cracking, meat tenderizing, and fish scaling. The top 4., expands into a downward dip, 6. the thumb rest curve, which naturally curves to the beginning of 5., the four-finger grip. The four finger grip handle 5. is covered with 7. a riveted surface that can be made of wood, bone, or aluminum cast that is attached with (2) screws, 11. (Although the aluminum is recommended, it is not required.) There is then an approximation of at least 1″ of smooth chrome 10. prior to beginning the elongated handle, 9. The four finger grip handle 5. expands into the elongated handle, 9. The four finger grip handle 5. is used for gripping in order to control usage as meat cleaver 1., as well as controlling usage of knife tips, lower 2., upper 3. and lightweight wood chopping or shaving of 1. The elongated handle 9. is used for extra wood chopping, meat chopping, and bone cracking power.

I claim:

1. A single universal hunting tool allowing for separate use of each portion of the tool comprising a slightly beveled blade with upper and lower surfaces where the blade has a spiky top of the upper surface, the spiky top then has a slight downward indentation at the back of the top creating a thumb rest, with a finger/hanger hole located in the center of the blade, the bottom of the lower surface is sharpened at it's edge that ends in pointed tip at the front end; the front edge of the lower surface from the tip is also slightly beveled with a sharpened edge and concave upward to the middle of the blade surface, then naturally curving outward forming a head, the head is not sharpened and meets the spiky top of said blade.

2. A universal hunting tool as in claim 1. wherein said blade is slightly beveled with a spiky top of the upper surface.

3. A universal hunting tool as in claim 1. wherein the surface of the blade has a fore finger/hanger hole within its center.

4. A universal hunting tool as in claim 1. wherein the bottom of the lower surface is sharpened and where the front of the blade is pointed at its tip.

5. A universal hunting tool as in claim 1. wherein the tip as in claim 4. concaves upward to the middle of the blade.

6. A universal hunting tool as in claim 1. wherein the front as in claim 4. curves outward forming a head, the head is not sharpened and meets the spiky top as in claim 2.

7. A universal hunting tool as in claim 1. where the spiky top as in claim 2. then having a slight downward indentation at the back of the top creating a thumb rest.

8. A combination of a four-finger grip and long handle where claims 1. through claims 7. can be used in multiple functions.
